(19) United States
(12) Patent Application Publication
(10) Pub. No.: US 2015/0140323 A1
(43) Pub. Date: May 21, 2015

(54) Tear resistant paperboard structure and method

(71) Applicant: Blair Holland, Attleboro, MA (US)

(72) Inventor: Blair Holland, Attleboro, MA (US)

(21) Appl. No.: 14/544,049

(22) Filed: Nov. 19, 2014

Related U.S. Application Data
(60) Provisional application No. 61/963,035, filed on Nov. 21, 2013.

(51) Int. Cl. B32B 27/10; B32B 27/32; B32B 27/08

(52) U.S. Cl. CPC B32B 27/10; B32B 27/08; B32B 27/32; B32B 2250/05; B32B 2250/40
USPC 428/335; 428/523; 428/337; 428/516

(57) ABSTRACT

A tear-resistant paperboard laminate includes a tear-resistant MD oriented Polyolefin core layer having first and second opposite sides. The tear-resistant paperboard laminate further includes a first paperboard layer bonded to the first side of the tear-resistant MD oriented Polyolefin core layer, with a first bonding medium. The tear-resistant paperboard laminate further includes a second paperboard layer bonded to the second side of the MD oriented Polyolefin core layer, with a second bonding medium. The first bonding medium and second bonding medium include a co-extrusion of thermoplastic material. The first bonding medium includes a first layer in contact with first paperboard layer and a second bonding medium in contact with the MD oriented Polyolefin core layer first side. A second bonding medium includes a first layer in contact with a second paperboard layer and a second layer in contact with the MD oriented Polyolefin core layer second side.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:

U.S. provisional patent application 61/963,035 entitled “Tear Resistant Paperboard Structure and Method”, naming Blair Holland as inventor, filed 21 Nov. 2013.

### FIELD OF USE

The present invention relates to a laminate sheet construction, structures made from the same, and methods for producing said structures . More particularly, the present invention relates to a laminated material having a Machine Directed (MD) oriented polypropylene core which utilizes extrusion laminate adhesive layers for optimal layer separation.

### DESCRIPTION OF PRIOR ART (BACKGROUND)

Known in the art are cartons for packaging various consumer products. Such cartons are made substantially of a paperboard material, and often include separate components which are movable with respect to one another. For example, known in the art are drug dispensing cartons or the like, where a sleeve houses an inner sliding member, and the consumer product, i.e. tablets, capsules, etc., are packaged in the inner sliding member. In order to access the drug units, a consumer slides the sliding member out of the sleeve. The sliding member may be provided in the form of a paperboard card or drawer. The same sliding member or another sliding member may provide information (instructions, disclaimers, etc.) concerning the product, for example an information card or a small booklet which is slidably engaged with the sleeve of the packaging.

Further known in the art, as illustrated in U.S. Pat. No. 7,681,733 B2 to GrossKoph, there is provided a use of the tear-resistant paperboard laminate for making a packaging structure, the packaging structure being of the type known as blister packaging, where two MD oriented laminates are stacked and offset 90 degrees, heat sealed or glued together, and wherein a PVC or PET blister is attached to one of the sheets.

Moreover, conventional packaging materials, such as for packaging unit dose pharmaceuticals, lack high tear-resistance and burst-resistance, which are desirable characteristics for various packaging applications including pharmaceutical packaging. Child resistance is a feature particularly desirable for unit dose pharmaceutical packaging to ensure that the package has sufficient integrity against tampering by children.

Moreover, it is commonly known that packaging for pharmaceutical products must be accessible by a person using the medication, but also child-resistant. This presents a number of drawbacks, particularly when the recipient of the medication is lacking manual dexterity or strength.

There is thus a need for an improved package and packaging material for providing improved tolerance in packages. Known in the art are various paperboard materials, including various tear-resistant paperboard materials, for manufacturing such packaging products. A conventional packaging is made of a tear-resistant paperboard laminate comprising a paperboard layer which is bonded to a tear-resistant polymer film such as polyethylene, polyester, or the like. The paperboard is clay coated, on the exposed side, for printability. Thus the resulting laminate has a clay coated paperboard side and a film side. The film side of the laminate has an adhesive quality, in that it has a “sticky” effect when in contact with another component.

This texture is undesirable, namely in packaging such as the ones described above, where an inner sliding component (or “insert”) is provided. Indeed, the stickiness of the film hinders the sliding motion of the insert, or of other movable parts in the packaging. Moreover, only the paperboard side of the laminate is printable. Therefore, if print is desired to appear on two sides of a substantially flat component of the packaging, the laminate material must be folded, which is results in a bulkier component and requires more of the laminate material. Moreover, the film side is not readily adherable. Therefore special adhesive substances and/or processes are required to adhere a component to the film side of the packaging, which results in increased manufacturing costs, etc. Furthermore, such conventional packaging material will tend to warp under certain conditions, such as high levels of humidity, etc., due to the asymmetry of the composition. This warping effect challenges the manufacturing of packages made with such materials and/or results in undesirable deformations in the final packages.

Moreover, despite advances in multi-layer film technology, the use of such films as the strength layer in a laminated structure with paperboard is still characterized by relatively poor tear characteristics. A conventional tear-resistant material has tear strength as measured by the Elmendorf tear propagation test of approximately 350 grams of force in machine direction and 400 grams of force in cross direction. The poor tear characteristics of the paperboard are imparted to the cross-laminated layers and the tear propagates through each of the layers.

Also, in fabricating products, the dissimilar materials of such laminates can present a number of problems including poor adhesion of the film to the paperboard surface, which can result in delaminating and other undesirable characteristics in the finished laminated product.

Multi-layer paperboard structures exist in the prior art and exhibit high tear-resistance, dimensional stability (independent of the relative humidity of the environment, without curling or warping of the laminated substrate), and printability on both sides of laminated substrate.

However, there is a need for an improved laminate composite with greater tear resistance and improved durability. Hence, in light of the aforementioned, there is a need for an improved packaging board which, by virtue of its design and components, would overcome some of the above-discussed prior art concerns as well as provide superior tear resistance to that which currently exists in the art.

### SUMMARY OF THE INVENTION

The object of the present invention is to provide a product and process which, by virtue of its design and components, satisfies some of the above-mentioned needs and is thus an improvement over other related packaging, tear-resistant paperboard materials and/or methods known in the prior art.

It is an object of the present invention to provide a paperboard packaging laminate that utilizes Machine Directed (MD) oriented film that is highly tear-resistant in one direction.

It is another object of the present invention to combine a first and second MD oriented laminate offset by 90 degrees to create a paperboard packaging laminate that is tear resistant in all directions.

It is another object of the present invention to provide a tear resistant paperboard packaging laminate that can be produced at a fraction of the cost of packaging laminates utilizing cross-directionally oriented films.

It is another object of the present invention to provide a paperboard packaging laminate with improved dimensional stability, and the ability to stay flat under varying environmental conditions.

It is another object of the present invention to provide a paperboard packaging laminate which provides double-sided printability with a minimum amount of material.

It is another object of the present invention to provide a laminated paperboard laminate for an improved packaging structure.

It is another object of the present invention to provide a laminated paperboard substrate for packaging that is child-resistant, yet easily opened by the intended consumer.

It is yet another object of the invention to provide a laminated paperboard substrate for packaging wherein the strength needed to open the package can be controlled.

In accordance with the present invention, the above mentioned objects are achieved, as will be easily understood, by a tear-resistant paperboard laminate such as the one briefly described herein and such as the one exemplified in the accompanying drawings.

According to embodiments of the present invention, there is provided a dimensionally stable, multi-layer paperboard structure that may be processed with conventional folding carton manufacturing equipment and techniques to form a multitude of tear-resistant prototypes offering similar or superior characteristics than those of similar prototypes made with conventional non tear-resistant paperboards or even commonly available tear-resistant paperboards consisting of various selected polymer films laminated to one side or both sides of said tear-resistant paperboards.

According to an aspect of the present invention, there is provided a tear-resistant paperboard laminate for making a tear-resistant packaging structure.

The tear-resistant paperboard laminate includes a tear-resistant MD oriented Polyolefin core layer having first and second opposite sides. The tear-resistant paperboard laminate further includes a first paperboard layer bonded to the first side of the tear-resistant MD oriented Polyolefin core layer, with a first bonding medium. The tear-resistant paperboard laminate further includes a second paperboard layer bonded to the second side of the MD oriented Polyolefin core layer, with a second bonding medium.

According to another aspect of the present invention, there is provided a packaging structure being made substantially of the tear-resistant paperboard laminate, where the laminate comprises an MD oriented Polyolyfin core layer, and two layers of the laminate are stacked and offset by offset by 90 degrees to create a laminate packaging that is tear resistant in all directions. Given the MD oriented core is extremely difficult to tear transverse to the MD direction, and offers little tear resistance transverse to the cross direction, the stacking of films offset by ninety degrees allows for a paperboard laminate that is tear resistant both vertically and horizontally.

According to yet another aspect of the present invention, there is provided a packaging structure comprising a first component and a second component being in sliding engagement with the first component, wherein at least one of the first and second components is made substantially of the tear-resistant paperboard laminate according to the present invention. Preferably, the first component forms a sleeve made substantially of the tear-resistant paperboard laminate according to the present invention and the second component forms an insert to slide along an inner wall of the sleeve. Preferably, the sleeve substantially encases the insert which is slidably engaged with inner walls of the sleeve. There may be provided one or more inserts being substantially made of the tear-resistant paperboard laminate according to the present invention.

According to another aspect of the present invention, there is provided a method of manufacturing a tear-resistant paperboard laminate. The method comprises steps of (a) providing an MD oriented tear-resistant polymer core layer having first and second opposite sides, (b) bonding with a first co-extrusion of thermoplastic material, a first paperboard layer to the first side of the MD oriented tear-resistant polymer core layer; and (c) bonding, with a second co-extrusion of thermoplastic material, a second paperboard layer to the second side of the MD oriented tear-resistant polymer core layer.

Preferably, the tear-resistant polymer core layer is corona treated on both sides, prior to lamination. The film is either purchased already corona treated or the corona treatment may be done on the laminator, if such a corona treatment station is available on the machine.

### BRIEF DESCRIPTION OF THE DRAWINGS

The foregoing and other objects, features, and advantages of the invention are apparent from the following detailed description taken in conjunction with the accompanying drawings in which:

FIG. 1 is a cross-sectional view of a paperboard laminate employing the principles of the present invention.

FIG. 2 is a prior art tear resistant laminated board.

FIG. 3, 4 are schematic diagrams representing an adhesive laminating process employing the principles of the present invention, the process for making the paperboard laminate.

### DETAILED DESCRIPTION

In the following description, the same numerical references refer to similar elements. The embodiments, geometrical configurations, materials mentioned and/or dimensions shown in the figures or described in the present description are preferred embodiments only, given for exemplification purposes only.

In the context of the present invention, any equivalent expression and/or compound words thereof known in the art will be used interchangeably, as apparent to a person skilled in the art. Furthermore, although the preferred embodiment of the present invention as illustrated in the accompanying drawings comprises components such as clay coatings, liquid adhesive, extrusion laminate concentrations, etc., and although the preferred embodiment of the tear-resistant paperboard laminate and corresponding parts thereof consists of certain geometrical configurations as explained and illustrated herein, not all of these components and geometries are essential to the invention, unless indicated, and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the tear-resistant paperboard laminate according to the present invention, as will be briefly explained herein and as can be easily inferred herefrom, by a person skilled in the art, without departing from the scope of the invention.

Furthermore, the order of the steps of the method described herein should not be taken as to limit the scope of the invention, as the sequence of the steps may vary in a number of ways, without affecting the scope or working of the invention, as can also be understood.

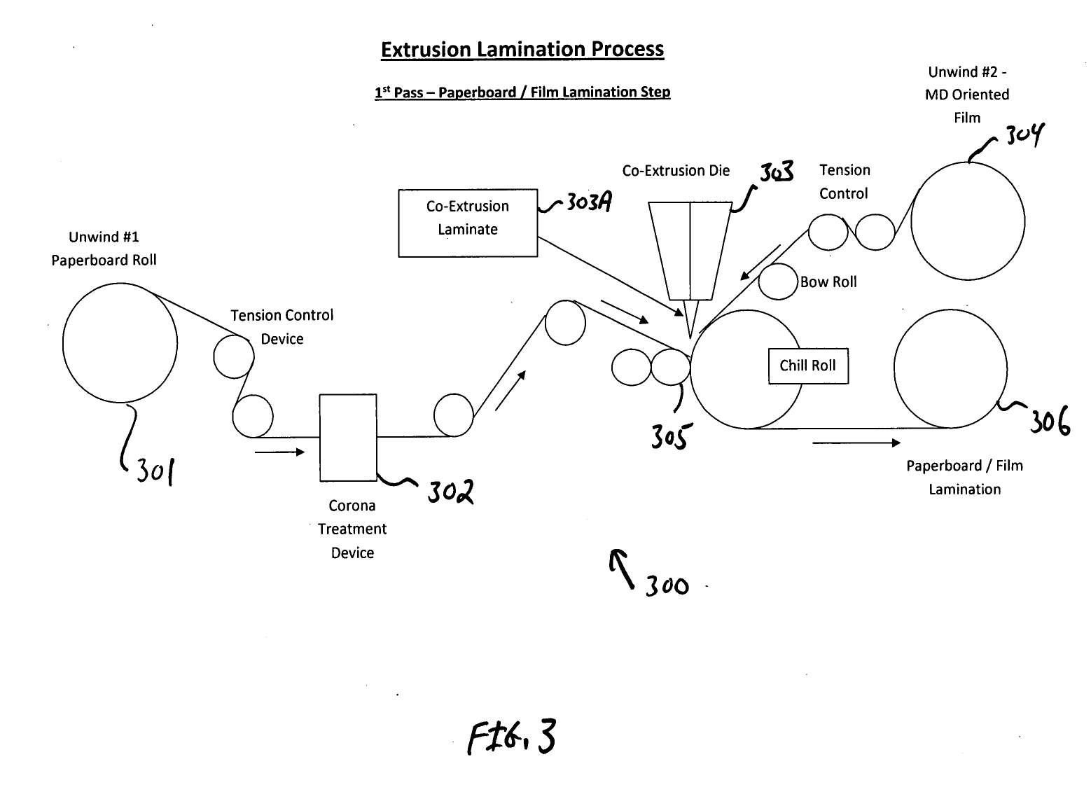

Referring to FIG. 2, there is illustrated a prior art tear-resistant paperboard laminate, 100, shown in a cross-sectional view. Such a conventional tear-resistant paperboard laminate usually comprises three distinct layers. First, a top board layer 101 consisting of a two sided paperboard with clay coated top first side and uncoated second side. The second layer 102 is a bonding or tie layer consisting of a liquid adhesive, molten LDPE, or the like, laminating together the uncoated second side of the top paperboard to one side of the tear-resistant layer. The third or bottom layer 103 is the tear-resistant layer consisting usually of a tear-resistant cross laminated polymer film such as polyethylene, polyester, or the like.

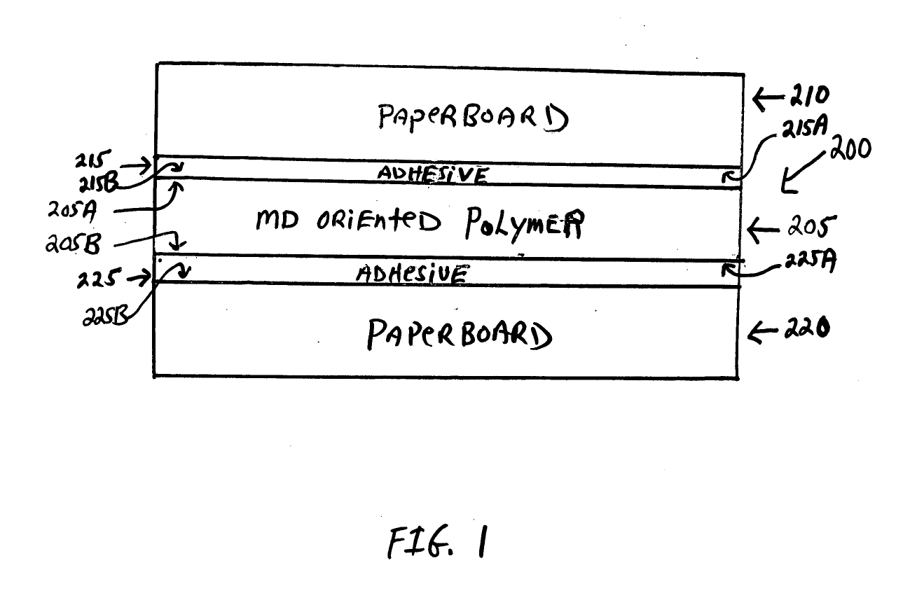

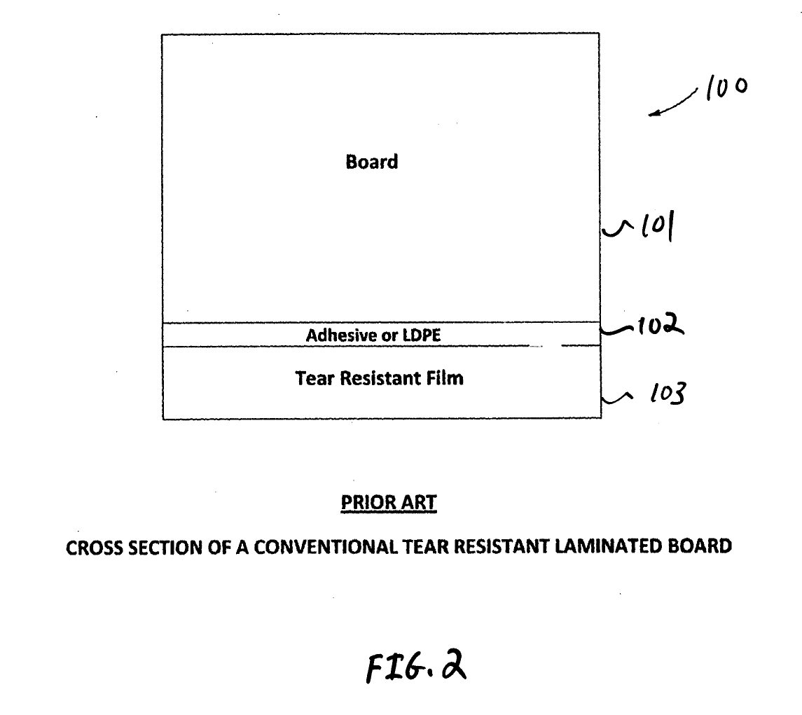

In contrast to prior art products known in the art, the tear-resistant paperboard laminate according to the present invention, as illustrated in FIG. 1, is a multi-layer paperboard laminate with an integral Machine Direction (MD) oriented polypropylene core having a high resistance to tearing in one direction. By stacking at least two layers offset by ninety degrees high tear resistance in all directions can be achieved at considerable cost savings. The laminates may be combined by heat sealing, gluing, or other comparable methods known in the art.

Preferably, the tear-resistant paperboard laminate is a multi-layer paperboard laminate with a Machine Direction (MD) oriented polyolefin core film (205), preferably the film gauge being from about 1 mil to about 3.0 mil. It was discovered during testing that the tear resistance offered by lighter gauge MD polyolefin film was similar to that of a heavier gauge MD polyolefin film. In fact, a film gauge of about 1.5 mil exhibited similar tear resistance to a 2.0 mil MD polyolefin film, and may be substituted thereby further reducing the cost of the paperboard laminate.

The MD oriented Polypropylene based films (205) of the present invention have a minimum tensile strength of 40,000 psi in the MD direction and a minimum tensile strength of 2,500 psi in the transverse or cross direction, as measured by ASTM standard D882. Referring to FIG. 1, there is shown a tear-resistant paperboard laminate 200 for making a tear-resistant packaging structure, according to an embodiment of the present invention. The tear-resistant paperboard laminate 200 includes an MD direction tear-resistant polymer core layer 205 having first and second opposite sides 205A and 205B. The tear-resistant paperboard laminate 200 further includes a first paperboard layer 210 bonded to the first side 205A of the MD direction tear-resistant polymer core layer 205, with a first bonding adhesive 215. The laminate 200 further includes a second paperboard layer 220 bonded to the second side 205B of the MD direction tear-resistant polymer core layer 205, with a second bonding adhesive 225.

Preferably, at least one of the first paperboard layer and the second paperboard layer is clay coated on an external side thereof, for providing printability. The first and/or second paperboard layer may comprise a substrate which may be: SBS (Solid Bleached Sulfate) 0.002″ to 0.012″, C1S (Coated 1 Side) board, CCNB (Clay Coated News Back) recycled board 0.002″ to 0.012″, and DWL (Double White Lined) board 0.002″ to 0.012″.

The first bonding adhesive 215 and second bonding adhesive 225 include a co-extrusion of thermoplastic material. In the preferred embodiment, first bonding adhesive 215 includes a first layer 215A in contact with paperboard 210 and a second layer 215B in contact with MD oriented tear-resistant polymer core layer 205 first side 205A.

In the preferred embodiment, first layer 215A is a blend of about 90% LDPE (Low Density Polyethylene) and about 10% polypropylene. In the preferred embodiment, second layer 215B is a blend of about 75% polypropylene and 25% polyethylene.

In the preferred embodiment, second bonding adhesive 225 includes a first layer 225B in contact with paperboard 220 and a second layer 225A in contact with MD oriented tear-resistant polymer core layer 205 second side 205B.

In the preferred embodiment, first layer 225B is a blend of about 90% LDPE and about 10% polypropylene. In the preferred embodiment, second layer 225A is a blend of about 75% polypropylene and 25% polyethylene. First layer 215A and first layer 225B are LDPE rich to provide enhanced bonding characteristics to paperboard 210, 220. Second layer 215B and second layer 225A are polypropylene rich to provide enhanced bonding characteristics to the MD direction polypropylene based tear-resistant polymer core layer 205, which is preferably polyolefin.

The concentration of LDPE is also necessary to stabilize the edges of the extrusion and for bonding of the top and bottom layers of the co-extrusion bonding adhesive 215 and 225. Further, the co-extruded adhesive layer adds additional layer separation thereby providing more disassociation in the layers of the tear-resistant paperboard laminate 200. More disassociation in the layers enables greater tear resistance since layers are able to slide relative to each other. MD oriented films have a high modulus of elasticity and yield a flat paperboard laminate 200.

In yet another preferred embodiment of the present invention, CaCO3 (Calcium Carbonate) is added to the co-extrusion layers 215A, 215B, 225B, and 225A. The addition of CaCO3 to increase thermal conductivity throughout paperboard laminate 200. Thermal conductivity of the laminate is critical when required by folding carton manufacturers to drive heat through the laminate to activate heat sealable coatings. These heat sealable coatings are typically water based and have activation temperatures between 180-200 F. Manufacturers and final processors prefer to use low dwell times and low heat sealable temperatures to avoid distortions in the paperboard laminate 200. The addition of CaCO3 has proven to increase the thermal conductivity of the laminate allowing more heat transfer for the same dwell time, which is highly desirable.

By stacking at least two layers offset by ninety degrees high tear resistance in all directions can be achieved at considerable cost savings. The laminates may be combined by heat sealing, gluing, or other comparable methods known in the art. Preferably, paperboards with a moisture content between about 5% to about 7% are less likely to degrade during the heat seal process. Under high temperatures, moisture trapped in the paperboard changes to steam causing the paperboard clay coated surface to exhibit puckering or bubbling, which was not evident with paperboard moisture contents between about 5% to about 7%.

Preferably, the first and second paperboard layers 210 and 220 are substantially structurally identical, in that they have substantially the same mechanical properties and are configured relatively symmetrically in relation to an axis formed along the core layer 205. In other words, the first paperboard layer 210 mirrors the second paperboard layer 220, in relation to the core layer 205. The resulting laminate is thus structurally symmetrical, in order to impart dimensional stability and avoid deformations of the laminate, such as warping, etc., when exposed to humidity or the like. Some minor differences between the first and second paperboard layers 210 and 220 are permissible without compromising the dimensional stability of the laminate, as can be understood by a person skilled in the art. For example, one paperboard may be clay coated while the other one is not. Preferably, the first and second paperboard are made of the same material and have approximately the same thickness. However, in some cases, the paperboards may be made of different materials and/or of varying thickness, so long as they are suitably similar in terms of structure and properties to impart dimensional stability, as can be understood by the skilled reader.

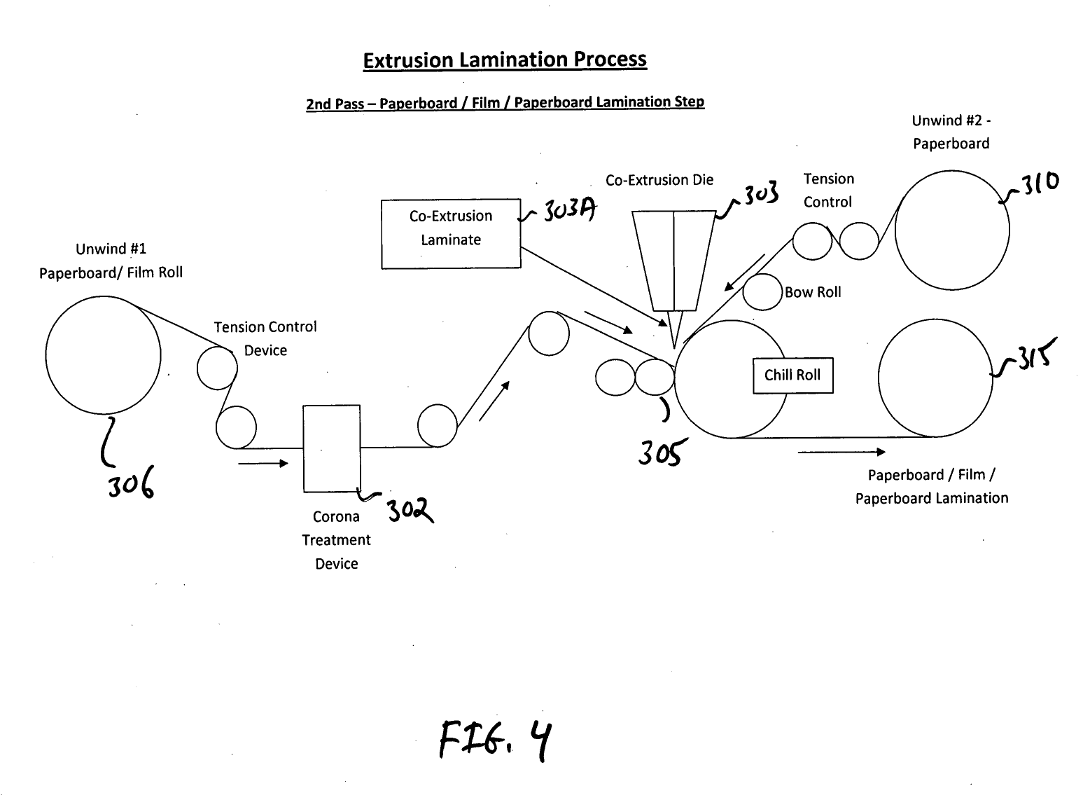

Referring now to FIGS. 3 and 4, there is shown method 300 of manufacturing a MD oriented paperboard laminate, according to a co-extrusion laminating process. Preferably, a paperboard 301 travels from an unwind roll 301 to a corona treatment chamber 302 to increase the surface tension or dyne level of the paperboard. The paperboard exits the corona treatment chamber 302 and travels to a co-extruder 303 to be coated with a co-extrusion laminate 303A as previously described herein. Thus, the first side of the paperboard 301 is coated with a co-extrusion laminate 303A. Concurrently, an MD oriented film 304 travels from another unwind roll coming into contact with the co-extrusion laminate 303 and they both enter between pressure rollers 305 to be joined together and rolled as a paperboard/film laminate 306.

Next, and referring to FIG. 4, the paperboard/film laminate 306 is gathered and passed for a second time through the extrusion lamination machinery. Paperboard/Film 306, being oriented for processing of the paperboard side only, travels from an unwind roll 306 to a corona treatment chamber 302 to increase the surface tension or dyne level of the paperboard side. Additionally, adhesion promotion other than corona treatment may be utilized. Such methods include ozone, flame and chemical priming. The paperboard exits the corona treatment chamber 302 and travels to a co-extruder 303 to be coated with a co-extrusion laminate 303A as previously described herein. Thus, the second side of the paperboard 301 is coated with a co-extrusion laminate 303A. Concurrently, a second paperboard 31 travels from another unwind roll coming into contact with the co-extrusion laminate 303 and they both enter between pressure rollers 305 to be joined together and rolled as a paperboard/film/paperboard laminate 315.

It should be understood that the foregoing description is only illustrative of the invention. Thus, various alternatives and modifications can be devised by those skilled in the art without departing from the invention. Accordingly, the present invention is intended to embrace all such alternatives, modifications and variances that fall within the scope of the claims.

I claim:

1. A tear resistant paperboard structure, comprising:
a Machine Direction (MD) oriented polypropylene core film layer having first and second opposite sides,
a top and bottom paperboard layer, each having first and second opposite sides, said top and bottom first opposite sides defining the external surfaces of said packaging structure;
a first and second adhesive layers, said first and said second adhesive layers each having first and second opposite sides, said top paperboard layer second opposite side bonded to said first adhesive layer first opposite side and said bottom paperboard layer second opposite side bonded to said second adhesive layer first opposite side;
said first adhesive layer second opposite side bonded to said polypropylene core film layer first opposite side and said second adhesive layer second opposite side bonded to said polypropylene core film layer second opposite side.

2. A tear resistant paperboard structure as in claim 1, wherein said paperboard is selected from the group consisting of solid bleached sulfate, clay coated news back, C1S board, and DWL board.

3. A tear resistant paperboard structure as in claim 2, wherein said top and bottom paperboard has a thickness from about 0.002 to about 0.012 inches.

4. A tear resistant paperboard structure as in claim 1, wherein said polypropylene core film layer is polyolefin.

5. A tear resistant paperboard structure as in claim 4, wherein said polyolefin film layer from about 1 mil to about 3.0 mils in thickness.

6. A tear resistant paperboard structure as in claim 1, wherein said MD oriented Polypropylene film layer has a minimum tensile strength of 40,000 psi in the MD direction and a minimum tensile strength of 2,500 psi in the transverse or cross direction.

7. A tear resistant paperboard packaging laminate as in claim 1, wherein said
first adhesive layer first side includes about 90% LDPE and about 10% polypropylene, and said first adhesive layer second side includes about 75% polypropylene and about 25% polyethylene.

8. A tear resistant paperboard packaging laminate as in claim 1, wherein said
second adhesive layer first side includes about 90% LDPE and about 10% polypropylene and said second adhesive layer second side includes about 75% polypropylene and about 25% polyethylene.

9. A tear resistant paperboard structure as in claim 1, wherein said top and bottom paperboard layers are substantially symmetrical in both dimension and material composition.

10. A tear resistant paperboard structure as in claim 7, wherein said first adhesive layer first side and said first adhesive layer second side further include CaCO3.

11. A tear resistant paperboard structure as in claim 8, wherein said second adhesive layer first side and said second adhesive layer second side further include CaCO3.

12. A tear resistant paperboard structure as in claim 1, wherein said top and bottom paperboard layers have a moisture content between about 5% to about 7%.

13. A tear resistant paperboard structure as in claim 1, wherein a plurality of said paperboard structures are stacked and offset by ninety degrees forming a reinforced paperboard structure.

14. A tear resistant paperboard structure as in claim 1, wherein said core film layer is corona treated.

15. A tear resistant paperboard structure, comprising:
a Machine Direction (MD) oriented polypropylene core film layer having first and second opposite sides,
a top and bottom paperboard layer, each having first and second opposite sides, said top and bottom first opposite sides defining the external surfaces of said packaging structure;
a first and second adhesive layers, said first and said second adhesive layers each having first and second opposite sides, said top paperboard layer second opposite side bonded to said first adhesive layer first opposite side and said bottom paperboard layer second opposite side bonded to said second adhesive layer first opposite side;
said first adhesive layer second opposite side bonded to said polypropylene core film layer first opposite side and said second adhesive layer second opposite side bonded to said polypropylene core film layer second opposite side;
wherein said first adhesive layer first side includes about 90% LDPE and about 10% polypropylene, and said first adhesive layer second side includes about 75% polypropylene and about 25% polyethylene; and
wherein said second adhesive layer first side includes about 90% LDPE and about 10% polypropylene and said second adhesive layer second side includes about 75% polypropylene and about 25% polyethylene.

16. A tear resistant paperboard structure, comprising:
a Machine Direction (MD) oriented polypropylene core film layer having first and second opposite sides,
a top and bottom paperboard layer, each having first and second opposite sides, said top and bottom first opposite sides defining the external surfaces of said packaging structure;
a first and second adhesive layers, said first and said second adhesive layers each having first and second opposite sides, said top paperboard layer second opposite side bonded to said first adhesive layer first opposite side and said bottom paperboard layer second opposite side bonded to said second adhesive layer first opposite side;
said first adhesive layer second opposite side bonded to said polypropylene core film layer first opposite side and said second adhesive layer second opposite side bonded to said polypropylene core film layer second opposite side;
wherein said first adhesive layer first side includes about 90% LDPE and about 10% polypropylene, and said first adhesive layer second side includes about 75% polypropylene and about 25% polyethylene; and
wherein said second adhesive layer first side includes about 90% LDPE and about 10% polypropylene and said second adhesive layer second side includes about 75% polypropylene and about 25% polyethylene;
wherein said top and bottom paperboard has a thickness from about 0.002 to about 0.012 inches;
wherein said polypropylene core film layer is polyolefin, having a thickness from about 1 mil to about 3.0 mils in thickness; and
wherein said polyolefin has a minimum tensile strength of 40,000 psi in the MD direction and a minimum tensile strength of 2,500 psi in the transverse or cross direction.

17. A tear resistant paperboard structure as in claim 16, wherein said top and bottom paperboard layers are substantially symmetrical in both dimension and material composition.

18. A tear resistant paperboard structure as in claim 16, wherein said first adhesive layer first side and said first adhesive layer second side further include CaCO3, and said second adhesive layer first side and said second adhesive layer second side further include CaCO3.

19. A tear resistant paperboard structure as in claim 16, wherein said top and bottom paperboard layers have a moisture content between about 5% to about 7%.

20. A tear resistant paperboard structure as in claim 16, wherein a plurality of said paperboard structures are stacked and offset by ninety degrees forming a reinforced paperboard structure.
